(19) United States
(12) Patent Application Publication
(10) Pub. No.: US 2021/0101659 A1
(43) Pub. Date: Apr. 8, 2021

(54) BIKE PEDAL WITH INTEGRAL OR REMOVABLE GUARD RAIL

(71) Applicant: Trevor Carlson, St. George, UT (US)

(72) Inventor: Trevor Carlson, St. George, UT (US)

(21) Appl. No.: 16/933,713

(22) Filed: Jul. 20, 2020

Related U.S. Application Data
(60) Provisional application No. 62/876,457, filed on Jul. 19, 2019.

(51) Int. Cl. B62M 3/08; B62M 3/16

(52) U.S. Cl. CPC B62M 3/08; B62M 3/16

(57) ABSTRACT

The present invention is a system and method for preventing a rider's shoe from slipping sideways off of a bike pedal while also allowing a foot to be rapidly moved in a desired direction off the bike pedal without having to first disengage the shoe from the bike pedal or move the foot in a particular direction in order to disengage the shoe.

### BACKGROUND

### Field of the Invention

This invention relates generally to a bicycle pedal. More specifically, the invention pertains to a one-sided or two-sided bike pedal that a rider can pedal on a first side or a second side, the pedal including an integral or an attachable and removable side guard, the side guard being disposed on an outer edge of the bike pedal and preventing a foot from slipping sideways off the first or second side of the bike pedal while still allowing rapid removal of a foot off the bike pedal.

### Description of Related Art

The ubiquitous bike pedal has been designed with different features for different types of riding. For example, many riders need a firm connection to the bike pedal in order to maintain a power stroke while pushing down on a pedal as well as when the foot is being lifted in an upward motion. There are several features that have been implemented to enable a rider to be more securely attached to a bike pedal in order to obtain a more efficient power stroke of the rider's legs.

A first example for improving a power stroke is through the use of a clip-in shoe that is more commonly referred to as a “clipless” bike pedal design. An example of a clipless bike pedal design for a road bike is shown in FIG. 1. This figure shows that a rider wears a shoe 10 that is designed to attach to a bike pedal 12. The attachment mechanism is provided through a complementary bike pedal and cleat system. In this system, the rider is able to attach a cleat 14 on the bottom of the shoe 10 to the bike pedal 12 using a slight twisting motion of the shoe to fit the cleat into a corresponding slot within the bike pedal.

It should be apparent that while the clipless bike pedal 12 increases the power stroke, it also prevents a rider's foot from accidentally sliding off of the bike pedal. However, it is also apparent that while the shoe 10 is rigidly attached to the bike pedal 12, this security comes at a cost. Specifically, the rider may not be able to quickly remove the shoe 10 from the bike pedal 12 in order to provide some stabilizing action with the shoe. Using the clipless design, the rider must move the foot 10 using a very a specific motion that enables the cleat 14 to disengage from the bike pedal 12. However, in an emergency or when the rider must react quickly, a user may not have sufficient time to perform this specific detachment motion which may result in a rider having an accident.

There are other bike pedal designs for preventing a foot from coming off while riding, but it is apparent that these designs also prevent a rider from quickly moving a foot off the bike pedal. For example, FIG. 2 is an example of a toe cage bike pedal design that provides a front enclosure 20 around the front portion of a shoe and a strap 22 that goes over the shoe. A rider slips the foot into the toe cage 20 and onto the bike pedal 10 in an attempt to obtain the benefits of an increased power stroke but without the complexity of using a clipless shoe. To be effective, the toe cage 20 is generally going to be a tight friction fit when a shoe is inserted into the toe cage. However, it is also apparent that the only way to disengage a shoe from the toe cage is to first move the shoe backwards out of the toe cage 20.

Another bike pedal design that may be used to increase a power stroke is a single or double strap-only design 24 that is disposed over the middle of the shoe and attached at both ends to the bike pedal 10. Again, the user must move a foot backwards to disengage the shoe from the bike pedal before it can be moved in a desired direction.

One common characteristic of all of the clipless 10, toe cage 20 and strap-only 24 designs for bike pedals is that they prevent rapid removal of a foot from the bike pedal without first performing a specific and often inhibiting foot movement. The cost of increasing a power stroke is that a specific movement to disengage a shoe from the bike pedal necessarily precludes immediate movement of a foot in a desired direction.

The inability to rapidly remove a foot from the bike pedal may be dangerous for certain types of riding. For example, mountain biking introduces riding concerns that may typically be beyond those of road bike riders. When mountain biking, it is desirable for the rider to be able to move a foot off the pedal and in a desired direction without any extra movement of the foot. Rapid foot movement off the bike pedal may be critical for a mountain biker in order to push off of an obstacle, pivot in a sudden turn or brace the foot to prevent a fall. It is very difficult to overcome an instinctive desire to immediately move a foot in a desired direction.

Accordingly, it would be an advantage over the prior art to provide a modification to a bike pedal that enables the user to move a foot more rapidly in a desired direction off of the bike pedal without having to first disengage the foot from a holding mechanism that is securing the foot to the bike pedal.

### BRIEF SUMMARY

The present invention is a system and method for preventing a rider's shoe from slipping sideways off of a bike pedal while also allowing a foot to be rapidly moved off the bike pedal and in a desired direction without having to first disengage the shoe from the bike pedal.

In a first aspect of the invention, a guard rail is disposed on an outer edge of a bike pedal, wherein the guard rail extends to a first side and a second side of the bike pedal.

In a second aspect of the invention, the guard rail is a removable attachment to the bike pedal.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a diagram of one example of a clipless bike pedal in the prior art.

FIG. 2 is a diagram of one example of a toe cage attachment on a bike pedal in the prior art.

FIG. 3 is a diagram of one example of a strap on a bike pedal in the prior art.

FIG. 4A is a perspective view of a first embodiment of the invention.

FIG. 4B is a top view of the first embodiment.

FIG. 4C is a side view of the first embodiment.

FIG. 4D is a front view of the first embodiment.

FIG. 5A is a top view of a second embodiment.

FIG. 5B is a side view of the second embodiment.

FIG. 5C is a front view of the second embodiment.

FIG. 6A is a top view of a third embodiment.

FIG. 6B is a side view of the third embodiment.

FIG. 6C is a front view of the third embodiment.

FIG. 7 is a profile view of an alternative shape of a guard rail.

FIG. 8 is a profile view of another alternative shape of a guard rail.

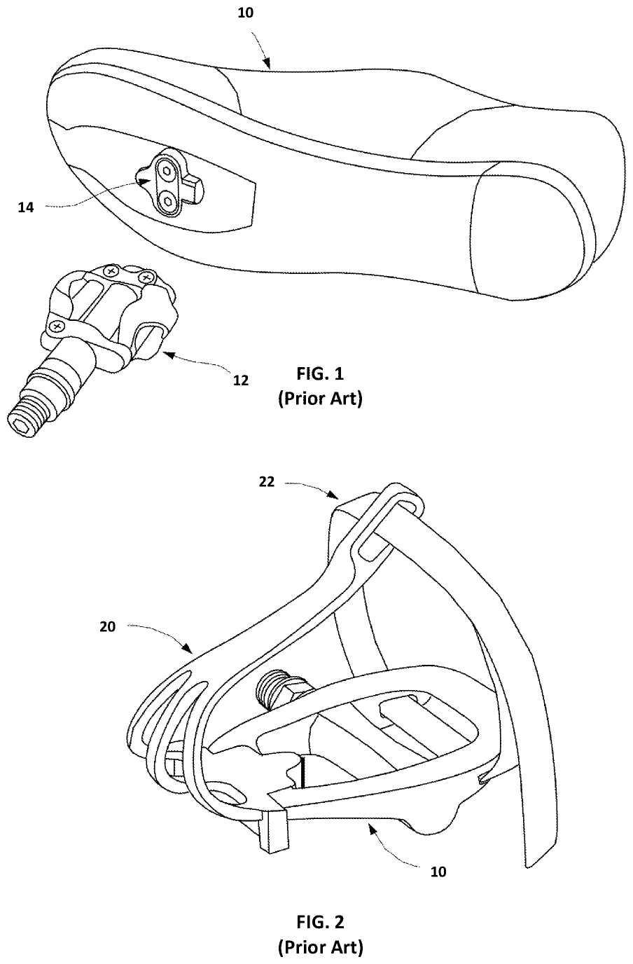

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow. It is also noted that the term “foot” may be used hereinafter when referring to a shoe being worn by a rider. Thus, it should be assumed that whenever the term “foot” is being used, what is actually being referred to is a shoe on a foot.

Mountain bike riders may be subjected to rides that are physically jarring because of the rough terrain that mountain bikes are able to traverse. A trail on an unpaved path is just going to be more difficult for the rider as compared to a paved path or road. Accordingly, it is important for a mountain bike rider to maintain contact with both bike pedals in order to be able to brace the rider and maintain control of the mountain bike.

Despite the desire to maintain control of the mountain bike at all times, inevitably, the rider may find that because of the path being followed, a rapid turn is necessary, an obstacle on the path must be avoided or a fall to the ground needs to be prevented. However, an examination of the different methods that may be commonly used by road bikes to maintain contact between a rider's feet and the bike pedals demonstrates that these other methods are unsafe for the typical mountain bike path because they require movement in a specific direction to disengage a foot from the bike pedal. When the required movement is not in the direction that the foot needs to move, critical time may be lost, and the rider may experience an accident or injury.

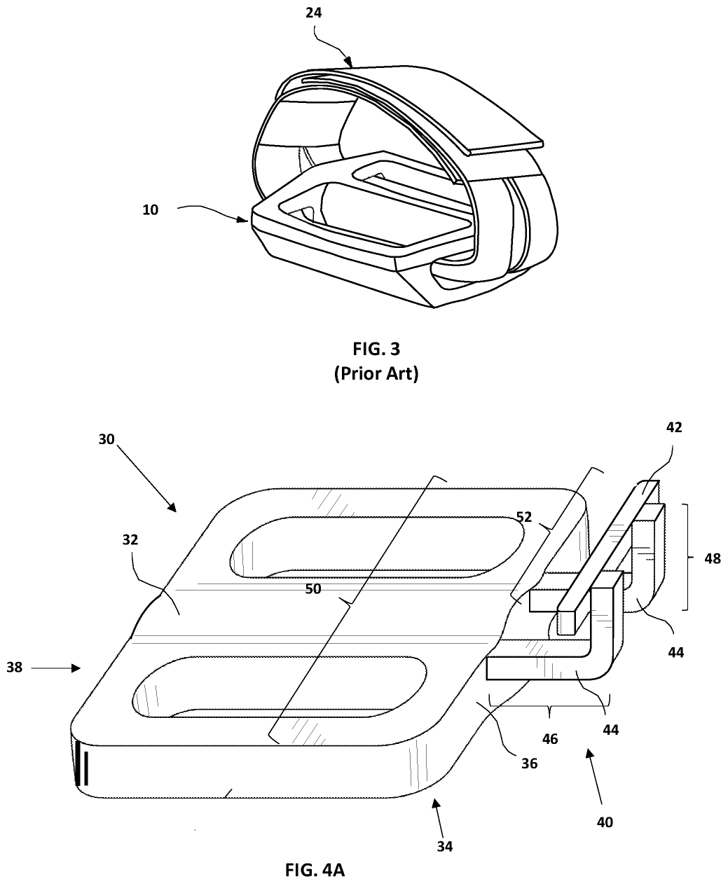

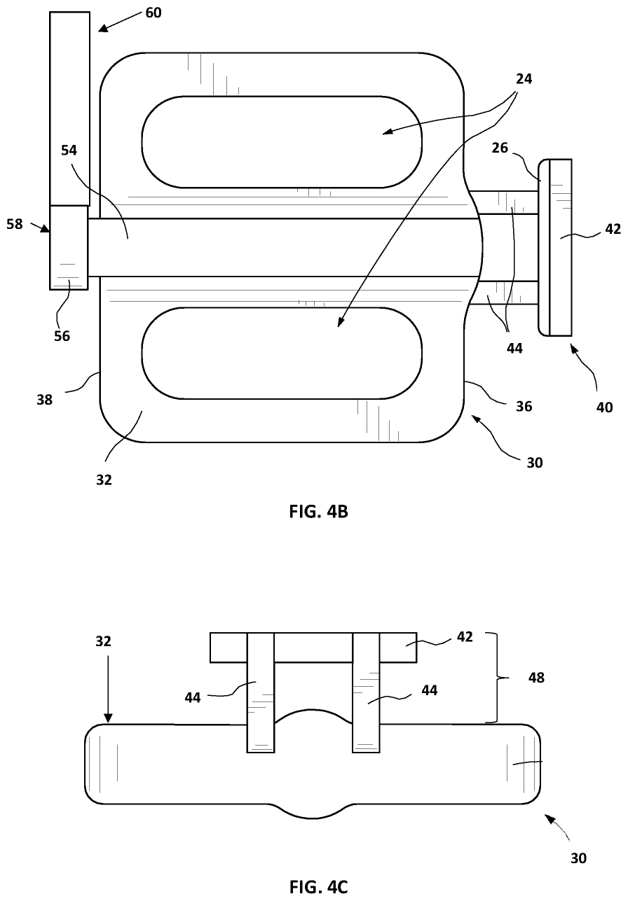

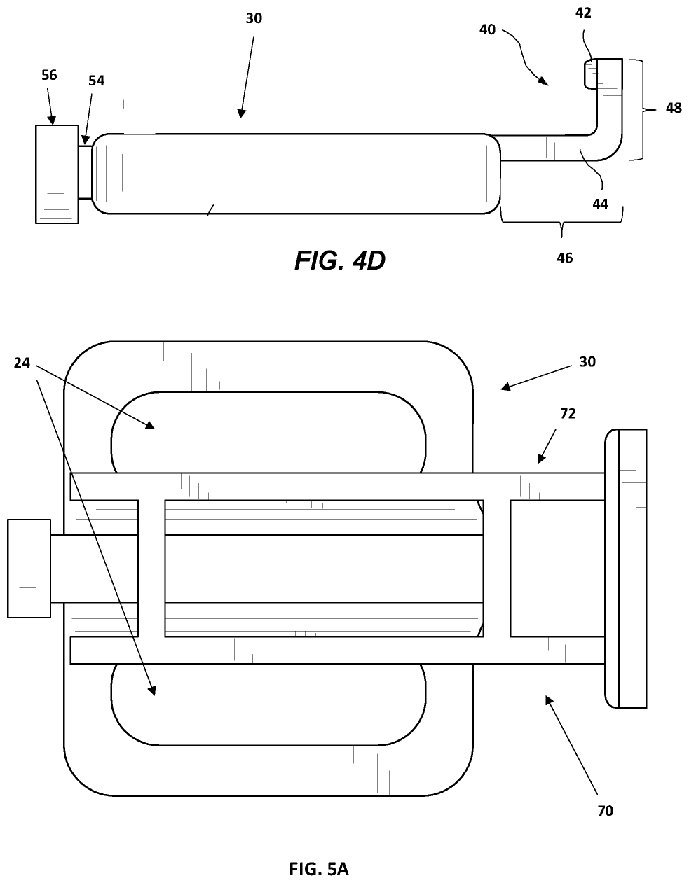

FIG. 4A is a perspective view of a first embodiment of a bike pedal 30. The bike pedal 30 includes a first planar side 32 (hereinafter “first side”) and an opposite second planar side 34 (hereinafter “second side”). The first side 32 and the second side 34 may both be usable sides of the bike pedal 30. The bike pedal 30 may generally have a substantially planar surface on the first side 32 and the second side 34 to provide a stable platform for a rider's shoe (not shown).

The first side 32 and the second side 34 of the bike pedal 30 may both be available for use by the rider when using the bicycle. The rider may flip over the bike pedal 30 to access either side, 32, 34, and it is sometimes referred to as a platform pedal. Platform pedals typically refer to any substantially planar bike pedal that does not have a toe cage.

The bike pedal 30 may be comprised of many different materials. The different materials are generally used for specific types of riding. For example, BMX riders typically use plastic pedals made of nylon, polycarbonate, or carbon reinforced plastic, although aluminum alloy and magnesium are not uncommon pedal body materials. In contrast, mountain bikers tend to use aluminum or magnesium because mountain bike pedals often make use of metal studs to offer a better grip for the shoe when the bike pedals are wet, muddy, and slippery.

The first side 32 (shown as a top side) and the second side 34 (shown as the bottom side) of the bike pedal 30 may also include a material on the planar surfaces 32, 34 to increasing friction between the bottom surface of a rider's shoe and the bike pedal 30 other than the metal studs. For example, the material may be rubber or another material with similar properties that prevent a shoe from slipping when the rider is pushing on the bike pedal 30.

The features of the bike pedal 30 described above are features that are commonly found in the prior art. However, a new feature of a first embodiment of the invention is shown in FIG. 4A as a single-sided guard rail 40. The guard rail 40 is disposed on an outer edge 36 of the bike pedal 30.

The guard rail 40 is shown being formed from 30 a side bar 42 and two extension arms 44 that extend outwards a first distance 46 in a direction away from or perpendicular to the outer edge 36 of the bike pedal. The first distance 46 that the two extension arms 44 project outwards from the bike pedal 30 may vary but is generally going to be a distance between 0.25 and 1.5 inches. The two extension arms 44 then change direction by forming an angle of approximately 90 degrees so as to extend a second distance 48 in a direction that is perpendicular to the first side 32 of the bike pedal 30 (and up out of the page in FIG. 4B).

The two extension arms 44 extend the second distance 48 above the first side 32 so as to form a barrier that prevents a foot disposed against the first side from slipping off the bike pedal 30 in the direction of the extension arms. The second distance 48 that the extension arms 44 may extend above the first side 32 of the bike pedal 30 is between approximately 0.25 and 2.0 inches.

It should also be understood that in the first embodiment, the side bar 42 is coupled to and extends between the two extension arms 44 to thereby form a final piece of the guard rail 40.

The two extension arms 44 and the side bar 42 that together form the guard rail 40 may be comprised of any appropriate materials sufficient to enable them to perform the function of holding the guard rail 40 in the proper position relative to the bike pedal 30. Furthermore, the two extension arms 44 may be comprised of a single extension arm if it is sufficiently strong, or they may be comprised of a plurality of arms that provide the same guard rail 40 functionality of the first embodiment.

What is important to understand is that the physical structure that forms the guard rail 40 is not critical. What is critical is that the guard rail 40 should be spaced some distance away from the outer edge 36 of the bike pedal 30, and that the guard rail also extend upwards relative to or above the first side 32 in order to prevent an object from slipping off the bike pedal. The guard rail 40 may be formed from rods or posts of any desired cross-section. The two extension arms 44 may also be formed as an integrated component of the bike pedal 30 or they may be attached to the bike pedal by any appropriate attaching mechanism.

While it is not preferred, in an alternative embodiment, the guard rail 40 may not first be extended outwards away from the outer edge 36 a second distance 46 but may instead immediately extend upwards above the first side 32 and be flush with the outer edge. However, this alternative embodiment may not include all of the benefits of the first embodiment.

It should also be noted that the absence of a guard rail 40 on an inner edge 38 of the bike pedal 30 near a crank is a significant feature. A crank is any lever arm that is coupled to a spindle of a bike pedal 30 that extends through the pedal and enables it to rotate.

A guard rail is not designed to prevent movement of a rider's foot inward towards the body of the bicycle but is instead disposed only on the outer edge 36. This may be an important feature because the shoe is free to move off the bike pedal 30 with as little interference with the bike pedal as possible. The presence of an inner guard rail could interfere with removal of the shoe from the bike pedal 30 and is therefore not a feature of the embodiments of the invention.

The guard rail 40 may provide support to the rider's foot if the foot slips or is bumped upwards off of the surface of the bike pedal 30. The guard rail 40 thus prevents the rider's foot from slipping off the bike pedal 30 when the bike pedal is slippery, or the terrain forces the foot off the pedal.

It is important to note that the guard rail 40 extends upwards vertically from the planar surface of the first side 32 of the bike pedal 30. By extending vertically, the guard rail 40 does not interfere with movement of the rider's foot off of or perpendicular to the first side 32 bike pedal 30. In other words, the guard rail 40 is not a cage and does not impede vertical movement of the foot. However, the vertical extension of the guard rail 40 does prevent the foot from slipping off the bike pedal 30 when the bumping and jarring of the terrain causes a slight lifting of the foot off the bike pedal. It has been demonstrated that the first embodiment of the invention improves the rider's ability to maintain contact between the foot and the bike pedal 30 when riding on typical unpaved paths.

It should also be explained that while the guard rail 40 does not interfere with vertical movement of the foot off the bike pedal 30, it also does not interfere with movement of the foot forwards or backwards off the bike pedal. Accordingly, when the rider needs to quickly put the foot forward, the rider may do so rapidly with a natural motion of the foot. In other words, the foot does not have to first move backwards out of a strap or cage or twist unnaturally to disengage a clipless bike pedal. The foot may be immediately moved forward or backward off the bike pedal 30.

As explained above, it is also important that no guard rail 40 is present on an inner edge 38 of the bike pedal 30. The absence of the guard rail 40 on the inner edge 38 is meant to ensure that as the rider lifts a foot off of the bike pedal 30, there is no other feature of the bike pedal that might impede movement or otherwise catch on the foot. This freedom of the foot to escape the bike pedal 30 and make minimal or no contact with the guard rail 40 is of critical importance.

Another feature of the guard rail 40 is that the first embodiment is single-sided. A single-sided guard rail 40 means that the guard rail extends vertically from a plane of the first side 32 and does not extend above the second side 34 of the bike pedal 30. With a single-sided guard rail 40, the rider may easily flip the bike pedal 30 with a foot to choose between a first side 32 of the bike pedal with the guard rail or a second side 34 without the guard rail.

Alternatively, a bike pedal 30 may be weighted to ensure that at rest, the first side 32 of the single-sided bike pedal is always facing up.

The first embodiment also shows in FIG. 4A that the guard rail 40 should have a minimal profile. In this first embodiment, a minimal profile is where the side bar 42 is shown to be shorter than a length 50 of the bike pedal 30. By also making the side bar 42 relatively thin, the weight of the first embodiment is minimized.

Furthermore, by making the length 52 of the guard rail 40 less than the length 50 of the bike pedal 30, the guard rail is less likely to interfere with removal of the foot, but still provide support to prevent the foot from slipping should it occur. It should be understood that the length of the side bar 42 may be adjusted as needed and is not limited to the length shown in FIGS. 4, 5 and 6.

Another aspect of the first embodiment shown in FIG. 4A is that the guard rail 40 is not shown as being immediately adjacent to the outer edge 36 of the bike pedal 30 but is instead extended the first distance 46 away from the outer edge. By positioning the guard rail 40 away from the outer edge 36, the guard rail may now function as an emergency support that is only used when the foot has actually started to slip off the bike pedal 30. In other words, the foot may or may not rest against the guard rail 40 when pedaling but is there when the foot starts to slip. Furthermore, by moving the guard rail 40 away from the outer edge 36, it is even less likely to interfere with movement of the foot off the bike pedal 30 when rapid foot removal is desired. The first distance 46 may be adjusted as needed. For example, the extension arms 44 may be replaceable or may be extended into or out of the bike pedal 30.

FIG. 4B is a top view of the bike pedal shown in FIG. 4A. FIG. 4B shows the bike pedal 30, a spindle 54, some gaps 24 through the bike pedal, and the integral single-sided guard rail 40 with extension arms 44 and the side bar 42. Notice the first distance 46 disposed between the outer edge 36 of the bike pedal 30 and the guard rail 40. A thin rubber strip 26 may also be disposed on the inner surface of the side bar 42. The spindle 54 is shown in dashed lines as it is inside the bike pedal 30.

The bike pedal 30 may be disposed on the spindle 54 that passes through an aperture that is disposed through a middle portion of the bike pedal. The bike pedal 30 may freely rotate around the spindle 54 on bearings. The spindle 36 may be rotatably coupled to a lever arm or crank 56 which provides the power to propel the bicycle as a force is applied to the crank through the bike pedal 30. The crank 56 is coupled at a first end 58 to the spindle 54 and at a second end 60 to the bicycle.

FIG. 4C is a side view of the bike pedal 30 shown in FIGS. 4A and 4B. FIG. 4C shows the bike pedal 30 and the single-sided guard rail 40. Notice the second distance 48 that the side bar 42 is raised above the first side 32 of the bike pedal 30. This second distance 48 may be adjusted by manufacturing extension arms 44 having different lengths when installing a bike pedal 30 with an integral guard rail 40.

FIG. 4D is a front and back view of the bike pedal 30 shown in FIGS. 4A, 4B, and 4C. FIG. 4D shows the bike pedal 30, a portion of the spindle 54 and the crank 56 and the single-sided guard rail 40 including the extension arms 44 and the side bar 42. Also shown is the first distance 46 between the bike pedal 30 and the guard rail 40, and the guard rail 20 is raised above the surface of the bike pedal the second distance 48. The first distance 46 between the bike pedal 30 and the guard rail 40 may be an adjustable distance, even for an integral guard rail.

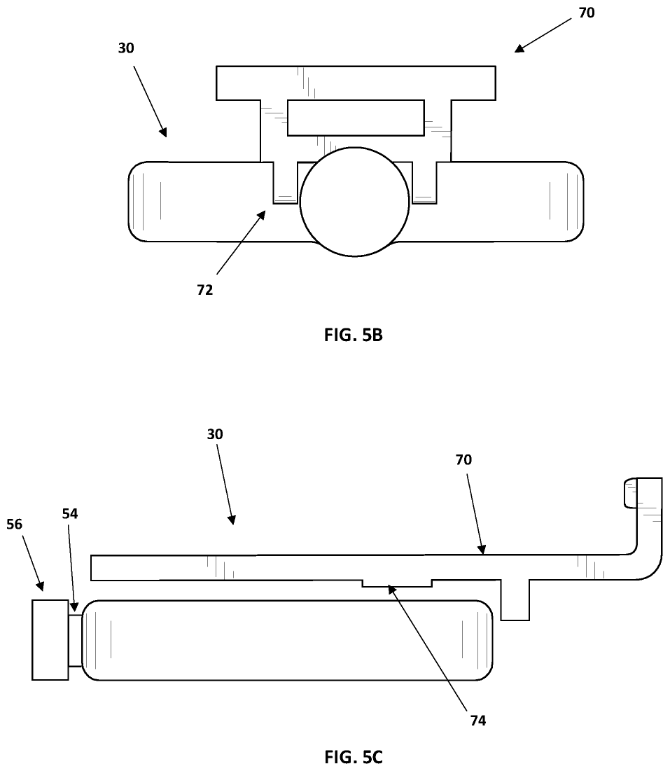

FIG. 5A is a top view of another embodiment of the invention. FIG. 5A shows the bike pedal 30, a portion of the spindle 54, the gaps 24 through the bike pedal and a removable single-sided guard rail 70. Notice the removable guard rail 70 now includes rails 72 that may be used to connect the removable guard rail to the bike pedal 30. Any convenient means of attaching the rails 72 to the bike pedal 30 should be considered to fall within the scope of the invention. For example, screws may be used to make the attachment.

FIG. 5B is a side view of the bike pedal 30 shown in FIG. 5A. FIG. 5B shows the bike pedal 30 and the removable single-sided guard rail 70. Notice that the removable guard rail 70 includes the rails 72 that enable temporary attachment to the bike pedal 30. Also notice that the removable guard rail 70 is raised above the surface of the bike pedal 30. The distance between the bike pedal 30 and the removable guard rail 70 may be an adjustable distance, even for an integral guard rail. Accordingly, adjusting the first distance 46 between the bike pedal 30 and the removable guard rail 70, as well as the second distance 48, should be considered an aspect of the embodiments of the invention.

FIG. 5C is a front view of the bike pedal 30 shown in FIGS. 5A and 5B. FIG. 5C shows the bike pedal 30, a portion of the spindle 54 and the crank 56 and the removable single-sided guard rail 70. Notice that the removable guard rail 70 is raised above the surface of the bike pedal 30. A projection 74 may extend down from the removable guard rail 70 and into one or more of the gaps 24 through the bike pedal 30. The vertical distance between the bike pedal 10 and the removable guard rail 70 may be an adjustable distance, even for an integral guard rail. Accordingly, adjusting the vertical distance between the bike pedal 30 and the removable guard rail 70 should be considered an aspect of the invention.

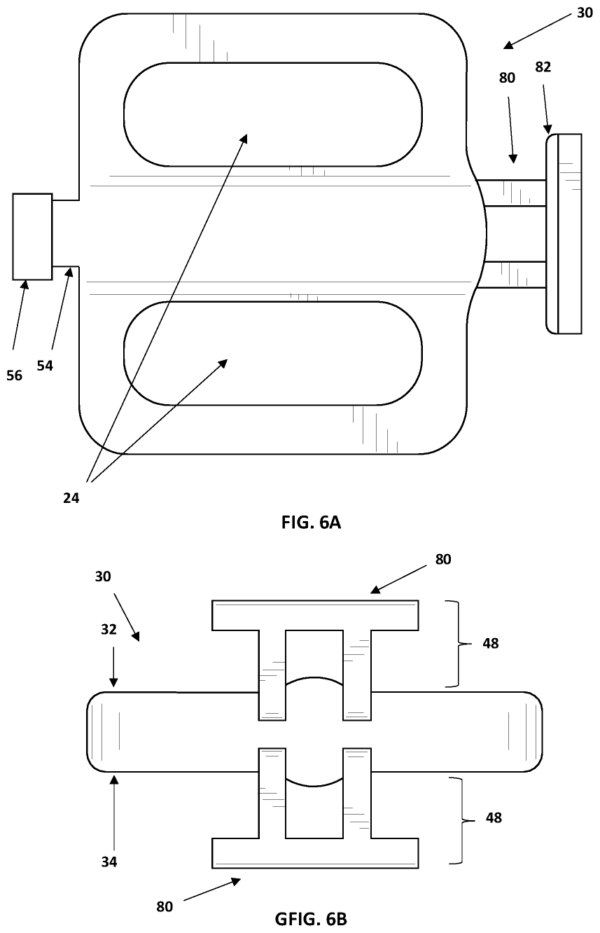

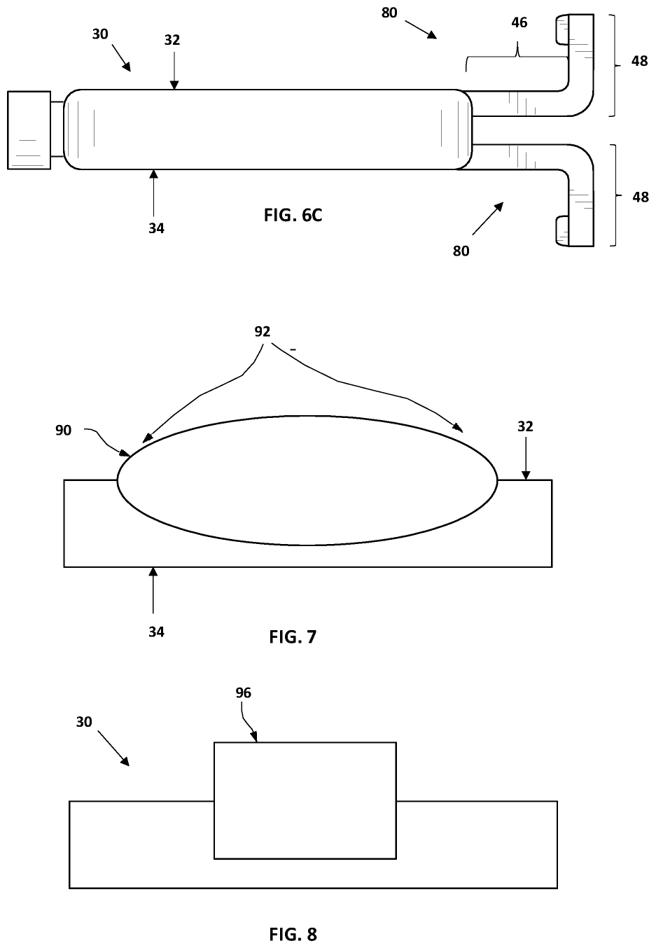

FIG. 6A is a top view of another embodiment of the invention. FIG. 6A shows the bike pedal 30, a portion of the spindle 54, the crank 56, the gaps 24 through the bike pedal and an integrated double-sided guard rail 80. A thin rubber strip 82 is also shown disposed on the inner surface of the integrated guard rail 80.

FIG. 6B is a side view of the bike pedal shown in FIG. 6A. FIG. 6B shows the bike pedal 30 and the double-sided guard rail 80. Notice the distance 48 that the double-sided guard rail 80 is raised above the first side 32 and the second side 34 of the bike pedal 30. This distance may be adjusted by manufacturing guard rails 80 having different heights when installing a bike pedal 30 with an integral double-sided guard rail 80.

FIG. 6C is a front view of the bike pedal 30 shown in FIGS. 6A and 6B. FIG. 6C shows the bike pedal 30, a portion of the spindle 54, the crank 56 and the double-sided guard rail 80. There is a distance 46 between the bike pedal 30 and the double-sided guard rail 80, and the double-sided guard rail 80 is raised a distance 48 above the first side 32 and the second side 34 of the bike pedal. The distance 48 between the bike pedal 30 and the double-sided guard rail 80 may be an adjustable distance, even for an integral guard rail.

FIGS. 6A, 6B and 6C are directed to an integral double-sided guard rail 80. It should be understood that a removable double-sided guard rail should also be considered to be within the scope of the invention. Thus, a removable double-sided guard rail would be a modification of the removable single-sided guard rail 70 shown in FIGS. 5A, 5B and 5C. The removable single-sided guard rail 70 would be implemented on opposites sides of the bike pedal 30.

Another aspect of the embodiments shown in all of FIGS. 4A through 6C is that the guard rail may also be implemented immediately adjacent to the outer edge 36 of the bike pedal 30 instead of being spaced apart the first distance 48. The embodiments of the invention would still have the advantages of only being implemented on a single edge of the bike pedal 30, thereby allowing the rider's foot to be rapidly removed while also providing support and preventing the rider's foot from slipping off the side of the bike pedal.

The embodiments of the invention shown in FIGS. 4A through 6C are all directed to a guard rail being implemented as a side bar shape 42. It should be understood that the profile of the guard rail may be changed to further reduce the possibility of accidentally catching the foot of the user when the foot is being removed from the bike pedal 30.

For example, while the thin bar shown 42 in FIG. 4A does have a low profile, the shape of the guard rail may be important. For example, the thin bar 42 has two overhanging ends that may catch on the rider's foot. Accordingly, other profiles for the guard rail 40 may also be considered to fall within the scope of the invention.

FIG. 7 shows a first alternative profile for a guard rail 90. This first alternative is half of an ellipse 92 extending above the surface of the bike pedal 30 such that the guard rail 90 is closer to the first side 32 of the bike pedal at the ends of the guard rail and higher in the middle. It may also be important that no portion of the guard rail 90 extend too far above the first side 32 or the second side 34 of the bike pedal 30. If the guard rail 90 is too high above the bike pedal 30, it is more likely to interfere with removal of the foot in a desired direction. Consequently, the specific shape of the guard rail 90 may be selected for a particularly low profile.

FIG. 8 shows that another alternative profile for the guard rail on the bike pedal 30 may be a solid rectangular shape 96 instead of a thin bar or half of an ellipse. While the rectangular shape may add weight, there is no portion for the rider's foot to be caught.

In an alternative embodiment, the profile of the guard rail may not be a bar, half of an ellipse or a solid rectangle, but may be any shape that does not interfere with movement of the foot of the bike pedal 30.

FIGS. 4A through 6C demonstrate that the single-sided and the double-sided guard rails 40, 70, and 80 may be an integral component that is manufactured as part of the bike pedal 30, or they may be removable items that are attached and removed as needed. Accordingly, an important aspect of the invention may be that the removable guard rail 70 may be attached to the bike pedal 10 using any convenient attachment mechanism and should not be considered to be a limiting aspect of the invention. There may be many different ways to attach the guard rail to the bike pedal. Different ways include but should not be considered as limited to a clamp, screws that include corresponding holes in the bike pedal 10, brackets or any other means for securing the guard rail to the bike pedal.

It was also disclosed that the embodiments of the invention shown above may use a rubber strip 26 on a portion of the guard rail to increase friction with a rider's foot. Another aspect of the embodiments is that the guard rail may have an inner surface that enables a foot to slide along it with only minimal friction or it may be manufactured in a way to increase friction with the foot when contact is made.

For example, the guard rail may be made of a material having a low coefficient of friction such as plastic or metal having a smooth surface. Alternatively, the guard rail may have a rough surface that increases friction, or it may have a material added to the guard rail that increases friction. For example, the guard rail may include rubber or a rubber-like material on an inner surface thereof.

Another embodiment of the invention is directed to the double-sided guard rail. The double-sided guard rail shown in FIGS. 5A through 5C shows that the guard rails on opposite sides of the bike pedal are substantially the same height. In this alternative embodiment, the guard rails may be made at different heights on the same bike pedal. For example, a first guard rail might be made at a first height that may be used when riding on terrain that is not as wet or rough. The second guard rail might then be made at a second taller height relative to the first guard rail. The side of the bike pedal with the taller guard rail might be used when the rider is in wetter conditions or on rougher terrain.

It is also noted that while the embodiments above refer to a rider being on a mountain bike, the embodiments of the invention may all be used on bike pedals of any bicycle, including all types of road bikes.

In summary, a first embodiment of the present invention is a system for improving a bike pedal having a single-sided guard rail, said system comprising a bike pedal including a first side, a second side that is coplanar with and opposite the first side, an inner edge, and an outer edge that is coplanar with and opposite the inner edge, and a guard rail coupled to the outer edge and disposed adjacent to but not in contact with the outer edge of the bike pedal, said guard rail spaced a first distance away from the outer edge and then extending upwards and disposed a second distance above the first side to thereby form a barrier that prevents an object disposed against the first side from sliding off the bike pedal in a direction of the outer edge. While the first guard rail is adjacent to the outer edge, the guard rail portion itself is not in physical contact but is spaced the first distance from the outer edge on some sort of extension arm.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A system for improving a bike pedal having a single-sided guard rail, said system comprising:
a bike pedal including a first side, a second side that is coplanar with and opposite the first side, an inner edge, and an outer edge that is coplanar with and opposite the inner edge; and
a guard rail coupled to the outer edge and disposed adjacent to but not in contact with the outer edge of the bike pedal, said guard rail spaced a first distance away from the outer edge and then extending upwards and disposed a second distance above the first side to thereby form a barrier that prevents an object disposed against the first side from sliding off the bike pedal in a direction of the outer edge.

2. The system as defined in claim 1 wherein the guard rail is further comprised of at least one arm that extends perpendicularly away from the outer edge of the bike pedal the first distance, wherein the at least one arm then turns approximately 90 degrees to thereby extend the guard rail the second distance above the first side.

3. The system as defined in claim 2 wherein the at least one arm of the guard rail is further comprised of two arms, and wherein a bar is disposed between the two arms.

4. The system as defined in claim 2 wherein the at least one arm of the guard rail that extends the second distance above the first side has a profile selected from the group of profiles comprised of a rectangular bar and half of an ellipse.

5. A system for improving a bike pedal having a removable single-sided guard rail, said system comprising:
a bike pedal including a first side, a second side that is coplanar with and opposite the first side, an inner edge, and an outer edge; and
a first guard rail having an attachment mechanism for coupling the first guard rail to the first side of the bike pedal, wherein the attachment mechanism enables the first guard rail to be disposed adjacent to the outer edge of the bike pedal, said first guard rail also spaced a first distance away from the outer edge and then extending upwards relative to the first side and disposed a second distance above the first side to thereby form a barrier that prevents an object disposed against the first side from sliding off the bike pedal in a direction of the outer edge.

6. The system as defined in claim 5 wherein the first guard rail is further comprised of at least one arm that extends perpendicularly away from the outer edge of the bike pedal the first distance, wherein the at least one arm then turns approximately 90 degrees to thereby extend the first guard rail the second distance above the first side.

7. The system as defined in claim 6 wherein the at least one arm of the first guard rail is further comprised of two arms, and wherein a bar is disposed between the two arms.

8. The system as defined in claim 5 wherein the system is further comprised of a second guard rail having an attachment mechanism for coupling the second guard rail to the second side of the bike pedal, wherein the attachment mechanism enables the second guard rail to be disposed adjacent to but not in contact with the outer edge of the bike pedal, said second guard rail spaced a first distance away from the outer edge and then extending upwards and disposed a second distance above the second side to thereby form a barrier that prevents an object disposed against the second side from sliding off the bike pedal in a direction of the outer edge.

9. A system for improving a bike pedal having a double-sided guard rail, said system comprising:
a bike pedal including a first side, a second side that is coplanar with and opposite the first side, an inner edge, and an outer edge;
a first guard rail disposed adjacent to the outer edge, said first guard rail also spaced a first distance away from the outer edge and then extending upwards and disposed a second distance above the first side to thereby form a barrier that prevents an object disposed against the first side from sliding off the bike pedal in a direction of the outer edge; and
a second guard rail disposed adjacent to but not in contact with the outer edge of the bike pedal, said second guard rail spaced a first distance away from the outer edge and then extending upwards and disposed a second distance above the second side to thereby form a barrier that prevents an object disposed against the second side from sliding off the bike pedal in a direction of the outer edge.

10. A method for improving a bike pedal having a single-sided guard rail, said method comprised of:
providing a bike pedal including a first side, a second side that is coplanar with and opposite the first side, an inner edge, and an outer edge;
providing a first guard rail disposed adjacent to but not in contact with the outer edge of the bike pedal;
spacing the first guard rail a first distance away from the outer edge; and
extending the first guard rail upwards a second distance above the first side to thereby form a barrier that prevents an object disposed against the first side from sliding off the bike pedal in a direction of the outer edge.

11. The method as defined in claim 10 wherein the method further comprises:
providing a second guard rail disposed adjacent to but not in contact with the outer edge of the bike pedal;
spacing the second guard rail the first distance away from the outer edge; and
extending the second guard rail upwards a second distance above the second side to thereby form a barrier that prevents an object disposed against the second side from sliding off the bike pedal in a direction of the outer edge.
